(19) United States
(12) Patent Application Publication
(10) Pub. No.: US 2005/0089058 A1
(43) Pub. Date: Apr. 28, 2005

(54) Method for wireless personal area network communication with enhanced contention access period mechanism, and system for the same

(75) Inventors: Jin-woo Hong, Seoul (KR); Dae-gyu Bae, Suwon-si (KR); Hyun-ah Sung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/973,910

(22) Filed: Oct. 27, 2004

(30) Foreign Application Priority Data
Oct. 28, 2003 (KR) 10-2003-0075666

(51) Int. Cl. H04L 12/413

(52) U.S. Cl. 370/445

(57) ABSTRACT

A method and system for increasing frame transmission efficiency in a Wireless Personal Area Network (WPAN) are provided. The method for wireless personal area network communication includes receiving information on a pseudo contention access period that allows data to be transmitted in contention in a superframe in which a beacon is not received from a device that schedules superframes if a number of consecutive beacon reception fails does not exceed a predetermined value, and transmitting data to a device comprised in a piconet in contention during the pseudo contention access period using the information on the pseudo contention access period. According to the method and the system, data transmission efficiency during a Contention Access Period (CAP) in the WPAN is increased.

### CROSS-REFERENCE TO RELATED APPLICATION

This application claims priority of Korean Patent Application No. 10-2003-0075666 filed on Oct. 28, 2003 in the Korean Intellectual Property Office, the disclosure of which is incorporated herein in its entirety by reference.

### BACKGROUND OF THE INVENTION

1. Field of the Invention

The present invention relates to a method and system for increasing frame transmission efficiency in a Wireless Personal Area Network (WPAN).

2. Description of the Related Art

With the development of digital technology, various types of digital products are widely used and make human life convenient. For example, Digital Versatile Disk (DVD) players, cable SetTop Boxes (STBs), Digital Video Cassette Recorders (DVCRs), Digital Televisions (DTVs), and Personal Computers (PCs) have been launched or are under development. Such digital products may be independently used but may be connected with each other through a single network. Such a network is referred to as a Personal Area Network (PAN). The PAN was usually implemented by a wired network using, for example, cables. However, as wireless communication technology is developed, a Wireless PAN (WPAN) is increasingly used.

Ultra WideBand (UWB), referred to as impulse radio, has been touted as a method for implementing WPAN communication. The UWB is technology for transmitting a large amount of digital data in a short-distance area using a low power and a wide-spectrum frequency range, which was developed by the Ministry of National Defense in the United States for military purposes. The UWB technology uses an ultra wideband of several GHz for wireless data transmission and allows high-speed (more than 1 Gbps) data transmission while a conventional 803.11a standard has a maximum transmission rate of 54 Mbps. As well as fast transmission, the UWB technology is advantageous in that its power consumption is low, only about 1/100 of the power needed by a mobile phone or a Wireless Local Area Network (WLAN) device. The Federal Communications Commission (FCC) in the United States prohibited commercial use of the UWB technology on the grounds that the UWB was developed for the military purposes and that a wide frequency band used in the UWB technology may interfere with frequency bands used in other existing technology. However, the commercial use of the UWB technology was permitted in February 2002 on the grounds that the UWB technology can solve a shortage of frequency slots since the UWB technology allows intermittent data transmission while using a wide frequency band and that the industrial position of the United States can be extended in a wireless communication market since military institutes and companies in the United States possess most of UWB source technology. An Institute of Electrical and Electronics Engineers (IEEE) 802.15.3 Working Group (WG) for building WPAN standards is working on standardization of the UWB technology. The IEEE 802.15.3 relates to a physical layer (PHY) and a Medium Access Control (MAC) layer. The present invention provides a method of increasing data transmission efficiency in a WPAN by enhancing the IEEE 802.15.3 MAC.

The IEEE 802.15.3 MAC is characterized by quickly forming a wireless network. In addition, the IEEE 802.15.3 MAC is not based on an Access Point (AP) like a conventional WLAN but is based on an ad-hoc network, that is, a piconet formed centering on a Piconet Coordinator (PNC). The IEEE 802.15.3 MAC also has a power management mode and provides a method of lowering power consumption.

FIG. 1 illustrates elements of a piconet.

An IEEE 802.15.3 piconet fundamentally includes devices (DEVs). A DEV having a special function among those DEVs is a PNC. A main function of the PNC is providing basic timing for the piconet via a beacon. The PNC also manages Quality of Service (QoS), a power saving mode, and access control. Such piconet is formed only when necessary without preplanning. In other words, it is present only as an ad-hoc network. Unlike in a WLAN, the DEVs in the piconet directly communicate with each other without using the PNC.

FIG. 2 illustrates a format of a superframe used in a piconet defined by an IEEE 802.15.3 standard.

As shown in FIG. 2, the IEEE 802.15.3 standard basically uses Time Division Multiple Access (TDMA). In other words, a MAC frame is disposed within a superframe in a temporal sequence. The superframe includes a beacon including control information, a Contention Access Period (CAP) for transmitting data in contention, and a Channel Time Allocation (CTA) period for transmitting data at an allocated time without contention. The CAP may be replaced with a Management CTA (MCTA) period. In the CAP, random access control is performed using Carrier Sense Multiple Access with Collision Avoidance (CSMA/CA). In the MCTA period, channel access is performed using slotted Aloha.

The CTA period includes a plurality of MCTA blocks and a plurality of CTA blocks. CTA is divided into two types: dynamic CTA and pseudo static CTA. The dynamic CTA may be located differently in superframes and can be used only when a beacon is received. On the contrary, the pseudo static CTA has a fixed location in superframes and can be used even when a beacon is not received. However, even the pseudo static CTA cannot be used if the number of consecutively lost beacons exceeds mMaxLostBeacons.

DEVs may transmit frames in the CAP or may be assigned a CTA and transmit frames in the CTA period. Usually, unlike in an IEEE 802.11 WLAN, a DEV cannot transmit a frame when it does not receive a beacon in the IEEE 802.15.3 WPAN. Meanwhile, a DEV issues a CTA request to the PNC in the CAP. If the DEV does not receive a beacon or loses contention, it cannot issue a CTA request and must wait for a subsequent superframe. In particular, a likelihood that a DEV does not receive a beacon increases under a poor channel environment. In this case, it could be difficult to transmit a frame in the CAP, and moreover, it may be difficult to issue a CTA request. Accordingly, a mechanism allowing a DEV to transmit a frame in the CAP even when the DEV does not receive a beacon normally is desired.

### SUMMARY OF THE INVENTION

The present invention provides a method for Wireless Personal Area Network (WPAN) communication allowing a frame to be transmitted in a Contention Access Period (CAP) even when a beacon is not normally received, and a system for the method.

According to an aspect of the present invention, there is provided a method for WPAN communication, including receiving information on a pseudo CAP that allows data to be transmitted in contention in a superframe in which a beacon is not received from a device that schedules superframes if a number of consecutive beacon reception fails does not exceed a predetermined value; and transmitting data to a device comprised in a piconet in contention during the pseudo CAP using the information on the pseudo CAP.

The pseudo contention access period is preferably within a contention access period comprised in a superframe comprising the pseudo contention access period.

The receiving of the information may comprise receiving a beacon broadcast by the device that schedules the superframes, and acquiring the information on the pseudo contention access period from a predetermined portion of the received beacon. The information on the pseudo contention access period is preferably acquired from information recorded in a payload comprised in a pseudo contention access period information element field defined in a frame body of the received beacon or from information recorded in a pseudo contention access period parameter added to a piconet synchronization parameters field comprised in the received beacon. The recorded information may indicate a time when the pseudo contention access period ends.

The method for WPAN communication may further comprise receiving information on a changed pseudo contention access period from the device that schedules the superframes. The received information on the changed pseudo contention access period is preferably acquired by receiving a beacon broadcast by the device that schedules the superframes, and acquiring the information on the pseudo contention access period from a predetermined portion of the received beacon. The received information on the changed pseudo contention access period is preferably acquired from information recorded in a payload comprised in a pseudo contention access period change information element field defined in a frame body of the received beacon or from information recorded in a changed pseudo contention access period parameter added to a piconet parameter change information element comprised in the received beacon. The recorded information may indicate a time when the changed pseudo contention access period ends and a superframe with which the changed pseudo contention access period begins.

In accordance with another aspect of the present invention, there is provided a method for wireless personal area network communication, comprising generating a first frame comprising information on a pseudo contention access period, which allows a device to transmit data in contention in a superframe in which a beacon is not received if a number of consecutive beacon reception fails in the device does not exceed a predetermined value, in response to a request to set the pseudo contention access period, and broadcasting the first frame. The first frame is preferably a beacon frame.

The generating of the first frame may comprise adding to a frame body a pseudo contention access period information element field having the information on the pseudo contention access period recorded therein. Alternatively, the generating of the first frame may comprise adding to a piconet synchronization parameters field a pseudo contention access period parameter having the information on the pseudo contention access period recorded therein. The information on the pseudo contention access period may indicate a time when the pseudo contention access period ends.

The method for wireless personal area network communication may further comprise generating a second frame comprising information on a changed pseudo contention access period in response to a request to change the pseudo contention access period, and broadcasting the second frame. The second frame is preferably a beacon frame. The generating of the second frame may comprise adding to a frame body a pseudo contention access period change information element field having a payload having the information on the changed pseudo contention access period recorded therein. Alternatively, the generating of the second frame may comprise adding to a piconet parameter change information element a pseudo contention access period change parameter having the information on the changed pseudo contention access period recorded therein. The recorded information may indicate a time when the pseudo contention access period ends and a superframe with which the changed pseudo contention access period begins.

In accordance with still another aspect of the present invention, there is provided a system for wireless personal area network communication, comprising a piconet coordinator generating a beacon frame comprising information on a pseudo contention access period, which allows a device to transmit data in contention in a superframe in which a beacon is not received if a number of consecutive beacon reception fails in the device does not exceed a predetermined value, in response to a request to set the pseudo contention access period, and broadcasting the beacon frame, and at least one device receiving the beacon frame comprising the information on the pseudo contention access period from the piconet coordinator and transmitting data to another device comprised in a piconet in contention using the information on the pseudo contention access period during the pseudo contention access period comprised in a superframe in which the device does not receive a beacon.

The piconet coordinator may generate another beacon frame comprising information on a changed pseudo contention access period in response to a request to change the pseudo contention access period and broadcasts the beacon frame. The information on the changed pseudo contention access period may indicate a time when the pseudo contention access period ends and a superframe with which the changed pseudo contention access period begins.

### BRIEF DESCRIPTION OF THE DRAWINGS

The above and other features and advantages of the present invention will become more apparent by describing in detail preferred embodiments thereof with reference to the attached drawings in which:

FIG. 1 illustrates elements of a piconet;

FIG. 2 illustrates a format of a superframe used in a piconet defined by an Institute of Electrical and Electronics Engineers (IEEE) 802.15.3 standard;

FIG. 3 illustrates a format of a normal frame according to the IEEE 802.15.3 standard;

FIG. 4 illustrates a format of a non-secure beacon frame according to the IEEE 802.15.3 standard;

FIGS. 5A through 5C illustrate a format of an Information Element (IE) indicating pseudo Contention Access Period (CAP) and a format of an IE indicating a change in the pseudo CAP, according to an embodiment of the present invention;

FIGS. 6A through 6D illustrate a format of an IE indicating a pseudo CAP and a format of an IE indicating that the pseudo CAP is changed, according to another embodiment of the present invention;

FIG. 7 is a flowchart of a procedure for using a pseudo CAP according to an embodiment of the present invention;

FIG. 8 is a flowchart of a procedure for changing a pseudo CAP according to an embodiment of the present invention;

FIG. 9 is a detailed flowchart of the procedure for using a pseudo CAP according to an embodiment of the present invention;

FIG. 10 is a detailed flowchart of the procedure for changing a pseudo CAP according to an embodiment of the present invention;

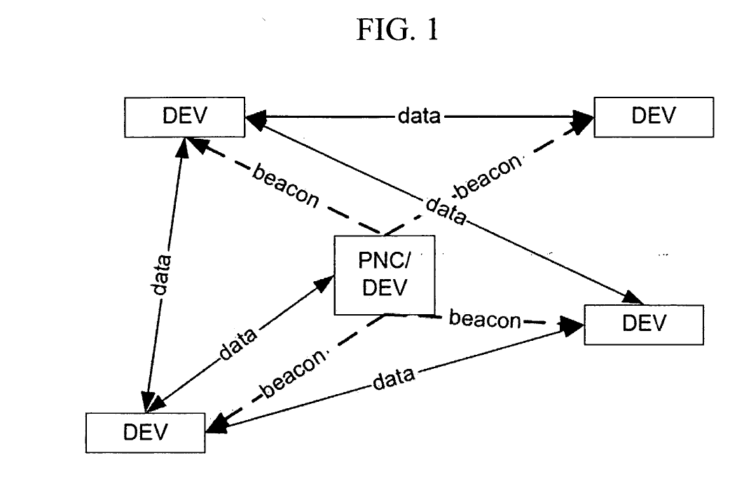

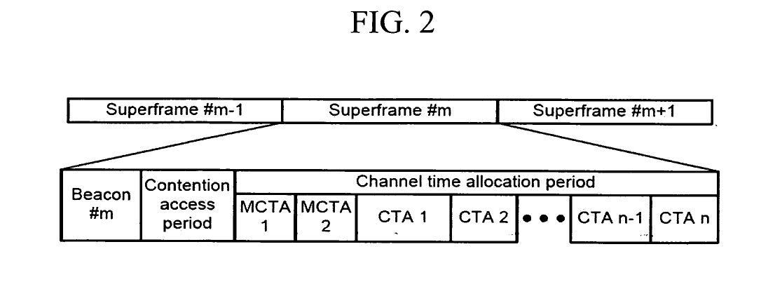

### DETAILED DESCRIPTION OF THE INVENTION

Preferred embodiments of the present invention will now be described with reference to the accompanying drawings.

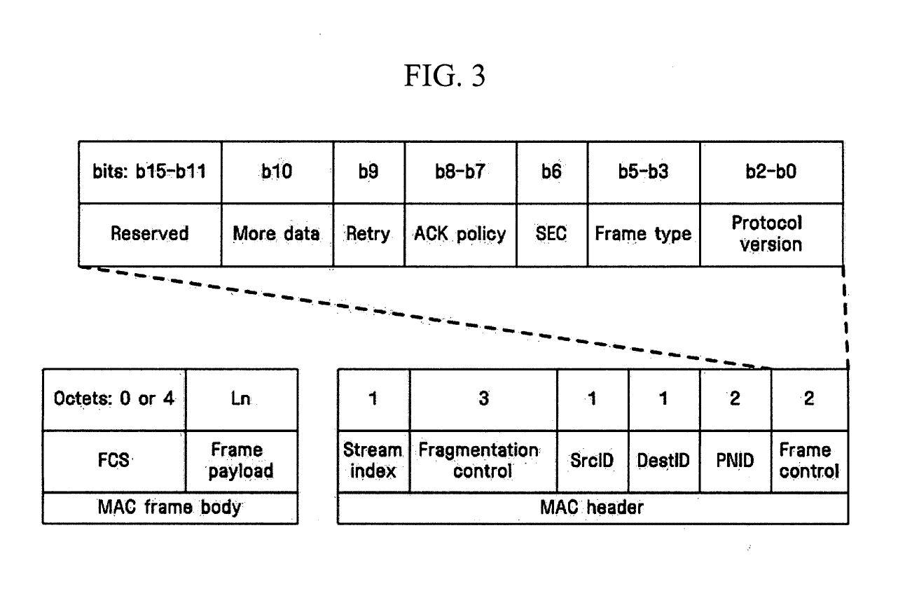

FIG. 3 illustrates a format of a normal frame according to an Institute of Electrical and Electronics Engineers (IEEE) 802.15.3 standard.

A Medium Access Control (MAC) header includes a 2-byte frame control field, a 2-byte piconet identification (PNID) field, a 1-byte destination ID (DestID) field, a 1-byte source ID (SrcID) field, a 3-byte fragmentation control field, and a 1-byte stream index field. A MAC frame body includes a frame payload field and a Frame Check Sequence (FCS) field.

In the frame control field, first three bits b2-b0 indicate a protocol version, subsequent three bits b5-b3 indicate a frame type, a subsequent one bit b6 indicates a security (SEC), subsequent two bits b8-b7 indicate an acknowledgement (ACK) policy, a subsequent one bit b9 indicates retry or non-retry, a subsequent one bit b10 indicates whether to use remaining time of a Channel Time Allocation (CTA) period, and subsequent five bits b15-b11 are reserved. Values 000, 001, 010, 011, and 100 of the bits b5-b3 indicating the frame type indicate a beacon frame, an immediate ACK frame, a delayed ACK frame, a command frame, and a data frame, respectively. Values 101 through 111 of the bits b5-b3 are reserved.

The PNID field includes a unique identifier for the piconet. The fragmentation control field is used to fragment a MAC Service Data Unit (MSDU) and command frames and recombine them. The stream index field is used to indicate a type of a stream. A value 0x00 of the stream index field indicates asynchronous data. A value 0xFD thereof indicates Management CTA (MCTA) traffic. A value 0xFE thereof indicates an unassigned stream.

In the MAC frame body, the frame payload field is used to transmit information (i.e., data) to a device (DEV) or DEVs in the piconet and has a variable length. The FCS field is used to detect an error that may occur during transmission of the frame.

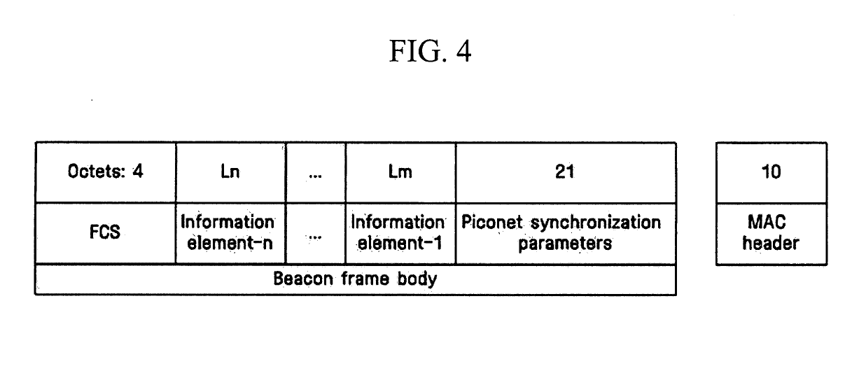

FIG. 4 illustrates a format of a non-secure beacon frame according to the IEEE 802.15.3 standard.

The beacon frame includes the MAC header shown in FIG. 3. In the MAC header of the beacon frame, the frame type field has the value 000, the DestID field includes a broadcast ID, and the SrcID field includes a Piconet Coordinator ID (PNCID).

A beacon frame body includes a piconet synchronization parameters field, a plurality of Information Element (IE) fields IE-1 through IE-n, and an FCS field. IEs supported by the IEEE 802.15.3 standard are shown in Table 1. The IE fields except for CTA IE fields may be located randomly. The CTA IE fields are located next to the piconet synchronization parameters field.

TABLE 1

| Element ID | | | Present in |
|---|---|---|---|
| hex value | Element | Subclause | beacon |
| 0x00 | Channel time allocation | 7.4.1 | As needed |
| 0x01 | BSID | 7.4.2 | In every beacon |
| 0x02 | Parent piconet | 7.4.3 | As needed |
| 0x03 | DEV association | 7.4.4 | As needed |
| 0x04 | PNC shutdown | 7.4.5 | As needed |
| 0x05 | Piconet parameter change | 7.4.6 | As needed |
| 0x06 | Application specific | 7.4.7 | As needed |
| 0x07 | Pending channel time map | 7.4.8 | As needed |
| | (PCTM) | | |
| 0x08 | PNC handover | 7.4.9 | As needed |
| 0x09 | CTA status | 7.4.10 | As needed |
| 0x0A | Capability | 7.4.11 | Non-beacon IE |
| 0x0B | Transmit power parameters | 7.4.12 | Non-beacon IE |
| 0x0C | PS status | 7.4.13 | As needed |
| 0x0D | Continued wake beacon | 7.4.14 | As needed |
| | (CWB) | | |
| 0x0E | Overlapping PNID | 7.4.15 | Non-beacon IE |
| 0x0F | Piconet services | 7.4.16 | Non-beacon IE |
| 0x10-0x7F | Reserved | | |
| 0x80-0xFF | Vendor specific | 7.4.17 | As needed |

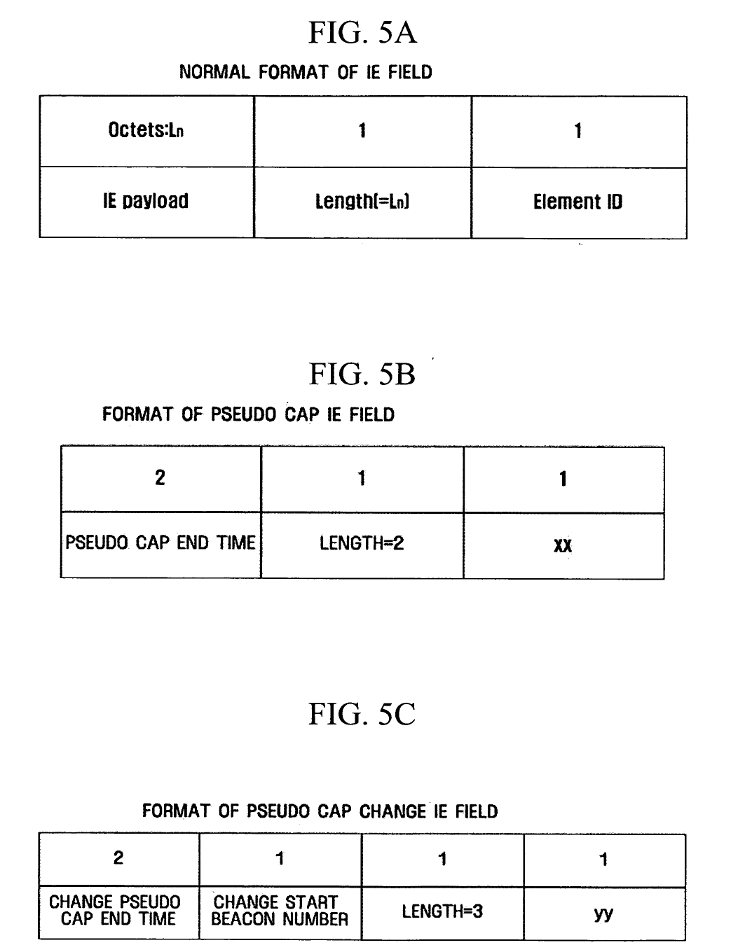

FIGS. 5A through 5C illustrate a format of an IE indicating pseudo Contention Access Period (CAP) and a format of an IE indicating a change in the pseudo CAP, according to an embodiment of the present invention.

In detail, FIG. 5A illustrates a normal format of an IE field. FIG. 5B illustrates a format of a pseudo CAP IE field defined by an embodiment of the present invention. FIG. 5C illustrates a format of a pseudo CAP change IE field defined by an embodiment of the present invention. Referring to FIG. 5A, the IE field includes an element ID field, an IE payload field, and a length field indicating a length of the IE payload field. Referring to FIG. 5B, the pseudo CAP IE field includes an element ID having a value “xx”, 1 byte indicating a length, and 2 bytes indicating an end time of a pseudo CAP in units of microseconds. Accordingly, the length is set to 2. Referring to FIG. 5C, the format of the pseudo CAP change IE field includes an element ID having a value “yy”, 1 byte indicating a length, 1 byte indicating a beacon number (i.e., a superframe number) at which the pseudo CAP starts changing, and 2 bytes indicating an end time of the changed pseudo CAP in units of microseconds. Accordingly, the length is set to 3.

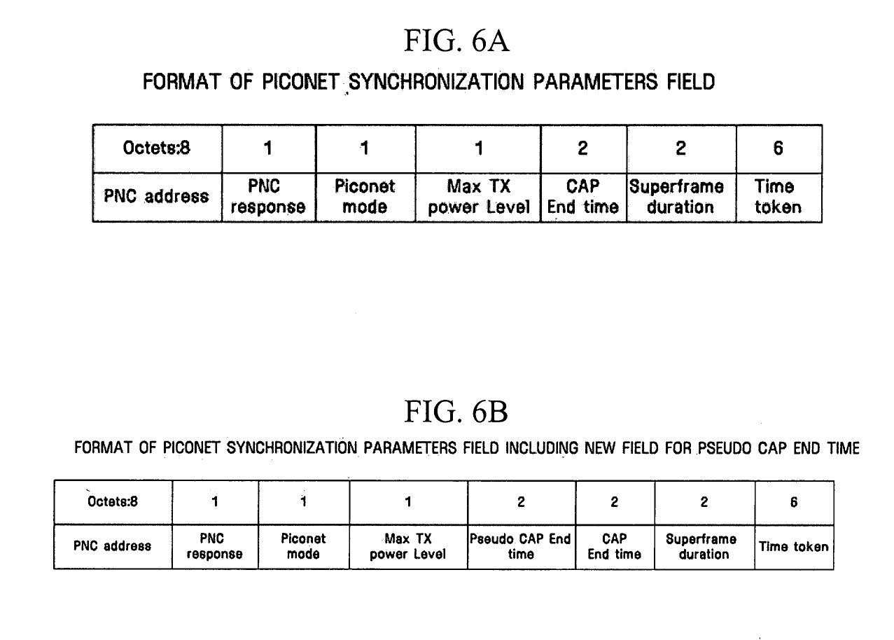

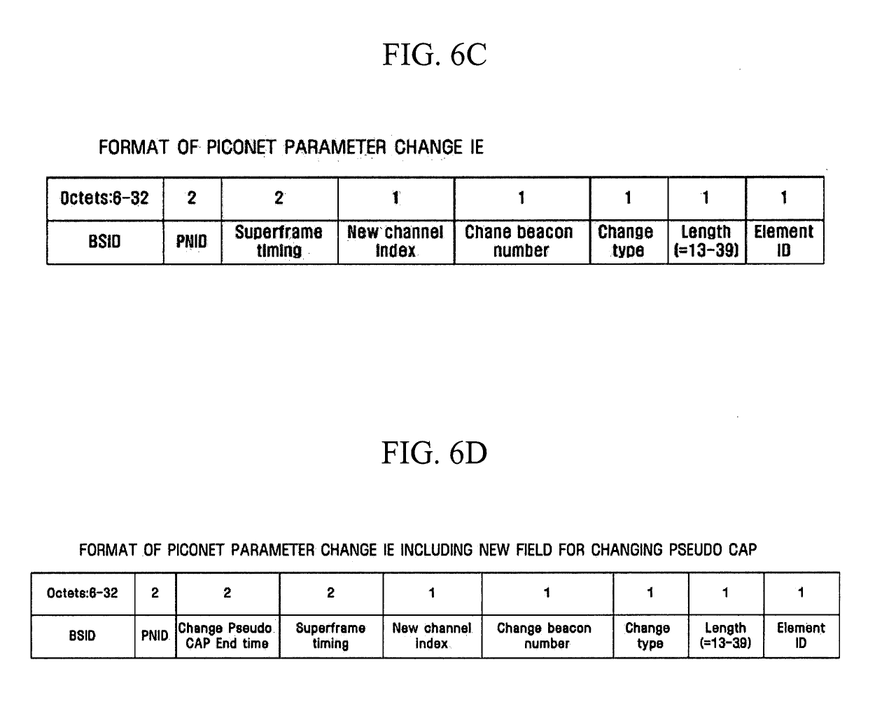

FIGS. 6A through 6D_illustrate a format of an IE indicating a pseudo CAP and a format of an IE indicating a change in the pseudo CAP, according to another embodiment of the present invention.

In detail, FIG. 6A illustrates a format of a piconet synchronization parameters field. FIG. 6B illustrates a format of a piconet synchronization parameters field including a new field according to the embodiment of the present invention. FIG. 6C illustrates a format of a piconet parameter change IE. FIG. 6D illustrates a format of a piconet parameter change IE including a new field according to the embodiment of the present invention.

Referring to FIGS. 6A and 6B, a time token field includes a 48-bit roll-over counter and increases per one beacon. A beacon number is defined by 16 Least Significant Bits (LSBs) of the time token field. A superframe duration field includes a length of a current superframe, which is defined by a time expressed in units of microseconds. A CAP end time field indicates an end time of a CAP for the current superframe. If the CAP end time field has a value 0, it is determined that a pseudo CAP is not set. A Max TX power level field is used to indicate a maximum transmission power allowed for the current superframe by a PNC in a piconet. A piconet mode field is used to define characteristics of the piconet and the superframe. The piconet mode field includes a 1-bit CAP data field, a 1-bit CAP command field, a 1-bit CAP association field, a 1-bit MCTA use field, a 1-bit security mode field, and three reserved bits. A PNC response field includes a 4-bit MCTA rate field and four reserved bits. The MCTA rate field indicates a frequency of open MCTAs or direct upward MCTAs for each DEV. A PNC address field includes a DEV address of the PNC. In the embodiment of the present invention, a pseudo CAP end time field is added to indicate a length of a pseudo CAP in microseconds.

Referring to FIGS. 6C and 6D, an element ID field and a length field in the piconet parameter change IE are the same as those in the IE field illustrated in FIG. 5A. A change type field indicates that a piconet parameter is changed. The details of the change type field defined by the IEEE 802.15.3 standard are shown in Table 2.

TABLE 2

| Change type | | Field to | Description |
|---|---|---|---|
| field value | Interpretation | decode | of field contents |
| 0 | PNID | PNID | The new PNID, 7.2.2, that |
| | | | will take effect beginning |
| | | | with the superframe |
| | | | which has the beacon |
| | | | number equal to the |
| | | | Change Beacon |
| | | | Number field. |
| 1 | BSID | BSID | The new BSID, 7.4.2, |
| | | | that will take effect |
| | | | beginning with the |
| | | | superframe which |
| | | | has the beacon |
| | | | number equal to |
| | | | the Change |
| | | | Beacon Number field. |
| 2 | MOVE | Superframe | The offset in microseconds |
| | | timing | between the beacon's |
| | | | expected transmission |
| | | | time and the time |
| | | | that it will be sent |
| | | | by the PNC, 8.10.1. |
| | | | The change occurs |
| | | | with the beacon |
| | | | which has the beacon |
| | | | number equal to the |
| | | | Change Beacon Number |
| | | | field. |
| 3 | SIZE | Superframe | The new superframe |
| | | timing | duration, 8.10.2, that |
| | | | will be used for the |
| | | | superframe which |
| | | | has the beacon |
| | | | number equal to |
| | | | the Change |
| | | | Beacon Number field. |
| 4 | CHANNEL | New channel | The channel index of |
| | | index | the PHY channel |
| | | | that the piconet will |
| | | | begin using the |
| | | | beacon that has |
| | | | the beacon number |
| | | | equal to |
| | | | the Change Beacon |
| | | | Number field. |
| | | | The mapping of |
| | | | the channel |
| | | | number is PHY |
| | | | dependent. For |
| | | | the 2.4 GHz PHY |
| | | | the mapping is |
| | | | defined in 11.2.3. |
| 5-255 | Reserved | None | |

A change beacon number field is used to change a beacon number for a current superframe when the change will take effect. A new channel index field indicates a changed channel index. A superframe timing field indicates an offset in microseconds between a beacon's expected transmission time and a time when the beacon is sent by a PNC. A PNID field and a BSID field indicate a piconet ID and a beacon source ID, respectively, that will take effect beginning with the superframe which has a beacon number equal to the change beacon number field. In the embodiment of the present invention, a change pseudo CAP end time field is defined to report a length of a changed pseudo CAP field. The change pseudo CAP end time field is set in association with the change type field and has a value selected from the reserved value in Table 2. In other words, one value among 5 through 255 may be selected as a change type field value. In embodiments of the present invention, a pseudo CAP is longer than a period of time while a frame having a biggest frame body is transmitted to prevent collision with a beacon frame. In addition, the pseudo CAP is within a CAP to prevent the pseudo cap from invading a CTA to be used by another DEV.

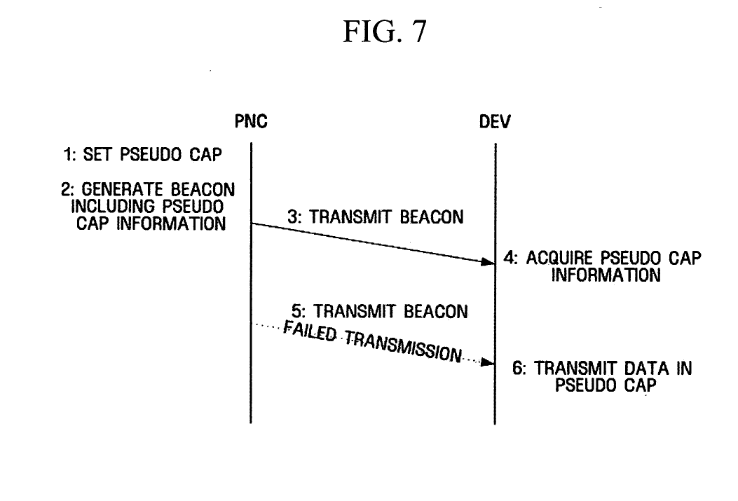

FIG. 7 is a flowchart of a procedure for using a pseudo CAP according to an embodiment of the present invention.

A PNC set a pseudo CAP in response to a pseudo CAP setting request. The pseudo CAP may be set by a user, set by the PNC's algorithm, for example, set to an initial value used when a DEV functions as the PNC, or set according to a DEV's request.

A beacon including information on a pseudo CAP (hereinafter, referred to as pseudo CAP information) is generated. Any one among the formats described in the above embodiments and other formats may be used to generate the beacon including the pseudo CAP information. In an embodiment of the present invention, the beacon including the pseudo CAP information is generated to inform a DEV of the pseudo CAP information. However, the present invention is not restricted thereto. For example, the PNC may broadcast a frame including the pseudo CAP information to DEVs during an MCTA period. It is preferable to use a format according to the embodiment illustrated in FIGS. 5A through 5C when the beacon including the pseudo CAP information is generated. When a format according to the embodiment illustrated in FIGS. 6A through 6D is used, conventional standards are changed, and therefore, a compatibility problem with other equipment may occur.

Thereafter, the beacon is broadcast at a beacon transmission time.

Then, a DEV receives the beacon and acquires the pseudo CAP information included in the beacon. Thereafter, if the number of consecutive beacon reception fails does not exceed a predetermined value, the DEV has a chance to transmit data in the pseudo CAP even though the DEV fails in receiving a beacon transmitted thereto after the pseudo CAP information is acquired. The DEV can transmit the data when it defeats other DEVs in contention.

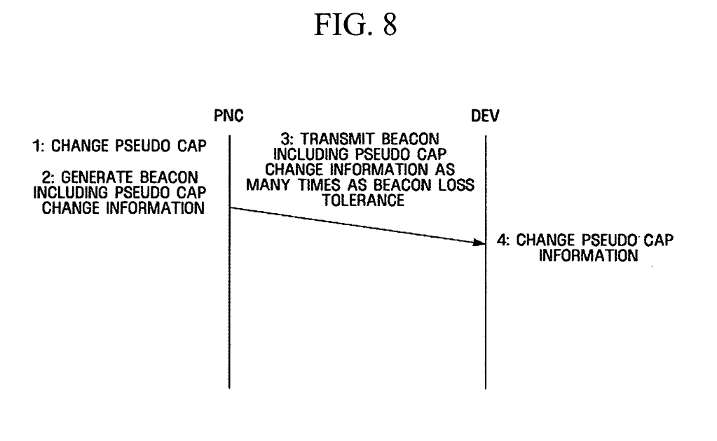

FIG. 8 is a flowchart of a procedure for changing a pseudo CAP according to an embodiment of the present invention.

A pseudo CAP is changed in response to a pseudo CAP change request. The pseudo CAP may be changed by a user or by a PNC's algorithm. For example, the pseudo CAP may be changed at predetermined intervals according to a program. Alternatively, the pseudo CAP may be changed according to another DEV's request.

A beacon including information on a changed pseudo CAP (hereinafter, referred to as pseudo CAP change information) is generated. Any one among the formats described in the above embodiments and other formats may be used to generate the beacon including the pseudo CAP change information. Like the procedure for using a pseudo CAP, a beacon may not be used to transmit the pseudo CAP change information to DEVs until a beacon transmission time. However, it is preferable to use a format according to the embodiment illustrated in FIGS. 5A through 5C taking into account compatibility with existing equipment defined by existing standards.

The beacon including the pseudo CAP change information is transmitted at a beacon transmission time. Even though the beacon including the pseudo CAP change information is transmitted, the pseudo CAP is not immediately changed. In a case where the pseudo CAP is immediately changed after the pseudo CAP change information is transmitted, if a DEV does not receive the beacon including the pseudo CAP change information and has only existing pseudo CAP information, the DEV not receiving the pseudo CAP change information may invade another DEV's CTA. There is no problem if the changed pseudo CAP is longer than the existing pseudo CAP. However, if the changed pseudo CAP is shorter than the existing pseudo CAP, a collision problem may occur. Accordingly, the beacon including the pseudo CAP change information is transmitted as many times as a beacon loss tolerance, which indicates the number of consecutive beacon reception fails that allows the DEV to use the existing pseudo CAP. The pseudo CAP change information includes information about a superframe beginning with which the pseudo CAP is changed. According to the IEEE 802.15.3 standard, a maximum beacon loss tolerance is set to 4.

The DEV that has received the pseudo CAP change information changes the existing pseudo CAP according to the pseudo CAP change information. A time when the existing pseudo CAP is changed in the DEV is also determined according to the information about a superframe beginning with which the pseudo CAP is changed.

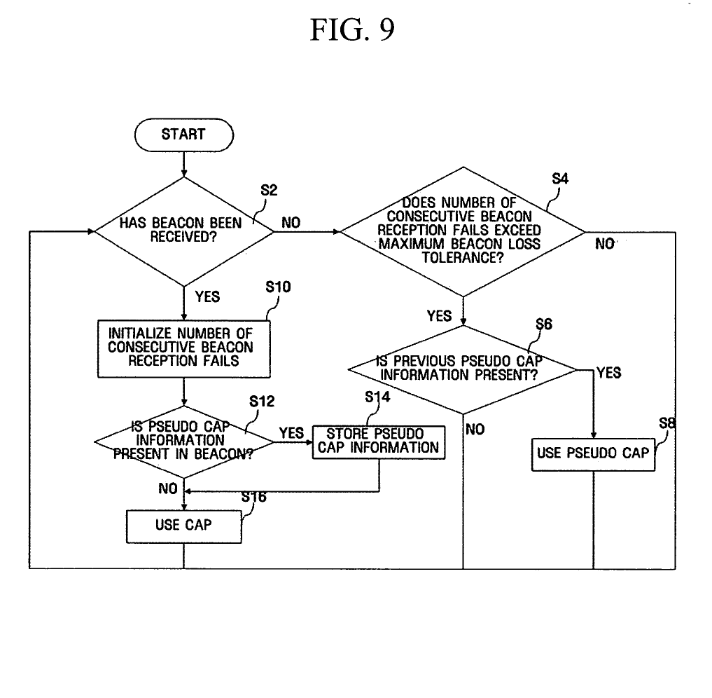

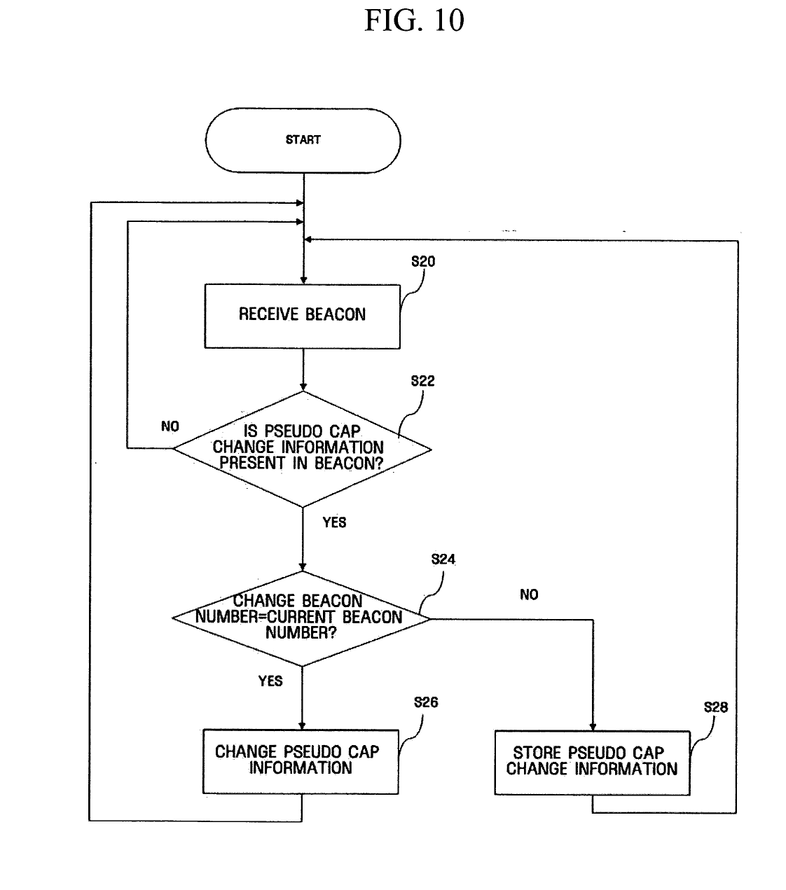

FIG. 9 is a detailed flowchart of the procedure for using a pseudo CAP according to an embodiment of the present invention, and FIG. 10 is a detailed flowchart of the procedure for changing a pseudo CAP according to an embodiment of the present invention.

Referring to FIG. 9, a DEV determines whether a beacon has been received in operation S2. If no beacon is received until a beacon transmission time, it is determined that a beacon has not been received. A CAP cannot be used when a beacon has not been received. If it is determined that a beacon has not been received, it is determined whether the number of consecutive beacon reception fails exceeds a maximum beacon loss tolerance in operation S4. If it is determined that the number of consecutive beacon reception fails exceeds the maximum beacon loss tolerance, the DEV cannot use a CAP or a pseudo CAP and must wait for a subsequent superframe. However, if it is determined that the number of consecutive beacon reception fails does not exceed the maximum beacon loss tolerance, the DEV determines whether it has previous pseudo CAP information in operation S6. If it is determined that the DEV has the previous pseudo CAP information, the DEV uses a previous pseudo CAP in operation S8. If it is not, the DEV waits for a subsequent superframe. Meanwhile, if it is determined that a beacon has been received, the number of consecutive beacon reception fails is initialized in operation S10. Thereafter, it is determined whether pseudo CAP information is present in the received beacon in operation S12. If it is determined that the pseudo CAP information is present in the received beacon, the pseudo CAP information is stored in operation S14 and a CAP is used in operation S16. Meanwhile, if the pseudo CAP information is not present in the received beacon, the CAP is used in operation S16.

Referring to FIG. 10, a beacon is received in operation S20. Next, it is determined whether pseudo CAP change information is present in the beacon in operation S22. If it is determined that the pseudo CAP change information is not present in the beacon, a subsequent beacon is waited for. If it is determined that the pseudo CAP change information is present in the beacon, it is determined whether a change beacon number is identical to a current beacon number in operation S24. If it is determined that a beacon number beginning with which a pseudo CAP is changed, i.e., the change beacon number, is the same as the current beacon number, existing pseudo CAP information is changed in operation S26. If it is determined that the change beacon number is not the same as the current beacon number, the pseudo CAP change information is stored in operation S28. A changed pseudo CAP is used beginning with receipt of a beacon corresponding to the pseudo CAP change information.

While the present invention has been particularly shown and described with reference to preferred embodiments thereof, it will be understood by those skilled in the art that various changes in form and details may be made therein without departing from the spirit and scope of the invention as defined by the appended claims and without changing any of its essential features. Therefore, it is to be understood that the above described embodiment is for purposes of illustration only and not to be construed as a limitation of the invention. The scope of the invention is given by the appended claims, rather than the preceding description, and all variations and equivalents which fall within the range of the claims are intended to be embraced therein.

According to the present invention, data transmission efficiency can be increased during a CAP in WPAN communication. DEVs having the improved transmission efficiency due to the fact that the present invention allows formation of a piconet with existing DEVs without a problem. The increase in the data transmission efficiency can be proved in the following exemplary cases on the assumption that a single superframe period is 50 ms, the number of frames to be transmitted is 30,000, the number of frames that can be transmitted during a single CAP is 10, and the number of frames that can be transmitted during a single pseudo CAP is 5.

In a case where beacons are continuously received without being lost, since 10 frames can be transmitted per one superframe, 3,000 superframes are needed to transmit all of the frames. Accordingly, it takes 150 seconds to transmit all of the frames. In this case, since an entire CAP can be used, data transmission efficiency is the same regardless of whether or not a pseudo CAP is used.

In another case, a period where two consecutive beacons are received and subsequently two consecutive beacons are not received is repeated. One period of the repetition corresponds to 4 superframes. When the pseudo CAP is not used, the number of frames that can be transmitted during a single period of the repetition is 20. On the other hand, when the pseudo CAP is used, the number of frames that can be transmitted during a single period of the repetition is 30. Accordingly, when the pseudo CAP is not used, 300 seconds are needed to transmit all of the frames. However, when the pseudo CAP is used, only 200 seconds are needed to transmit them all. Consequently, when the pseudo CAP is used, the data transmission efficiency is increased by 50%.

In still another case, a period where one beacon is received and subsequently four consecutive beacons are not received, is repeated. When the pseudo CAP is not used, only 10 frames can be transmitted per five superframes. On the other hand, when the pseudo CAP is used, 30 frames can be transmitted per five superframes. Accordingly, when the pseudo CAP is not used, 750 seconds are needed to transmit all of the frames. However, when the pseudo CAP is used, only 250 seconds are needed to transmit them all. Consequently, when the pseudo CAP is used, the data transmission efficiency is increased three times.

As described above, when the present invention providing a mechanism allowing use of a pseudo CAP is used, communication performance is remarkably increased in a contention period when beacons are lost due to a poor channel environment.

1. A method for wireless personal area network communication, comprising:
receiving information on a pseudo contention access period that allows data to be transmitted in contention in a superframe in which a beacon is not received from a device that schedules superframes if a number of consecutive beacon reception fails does not exceed a predetermined value; and
transmitting data to a device in a piconet in contention during the pseudo contention access period using the information on the pseudo contention access period.

2. The method of claim 1, wherein the pseudo contention access period is within a contention access period comprised in a superframe comprising the pseudo contention access period.

3. The method of claim 1, wherein the receiving of the information comprises:
receiving a beacon broadcast by the device that schedules the superframes; and
acquiring the information on the pseudo contention access period from a predetermined portion of the received beacon.

4. The method of claim 3, wherein the information on the pseudo contention access period is acquired from information recorded in a payload comprised in a pseudo contention access period information element field defined in a frame body of the received beacon.

5. The method of claim 3, wherein the information on the pseudo contention access period is acquired from information recorded in a pseudo contention access period parameter added to a piconet synchronization parameters field comprised in the received beacon.

6. The method of claim 4, wherein the recorded information indicates a time when the pseudo contention access period ends.

7. The method of claim 5, wherein the recorded information indicates a time when the pseudo contention access period ends.

8. The method of claim 1, further comprising receiving information on a changed pseudo contention access period from the device that schedules the superframes.

9. The method of claim 8, wherein the received information on the changed pseudo contention access period is acquired by receiving a beacon broadcast by a device that schedules the superframes, and acquiring the information on the pseudo contention access period from a predetermined portion of the received beacon.

10. The method of claim 8, wherein the received information on the changed pseudo contention access period is acquired from information recorded in a payload comprised in a pseudo contention access period change information element field defined in a frame body of the received beacon.

11. The method of claim 9, wherein the received information on the changed pseudo contention access period is acquired from information recorded in a changed pseudo contention access period parameter added to a piconet parameter change information element comprised in the received beacon.

12. The method of claim 10, wherein the recorded information indicates a time when the changed pseudo contention access period ends and a superframe with which the changed pseudo contention access period begins.

13. The method of claim 11, wherein the recorded information indicates a time when the changed pseudo contention access period ends and a superframe with which the changed pseudo contention access period begins.

14. A method for wireless personal area network communication, comprising:
generating a first frame comprising information on a pseudo contention access period, which allows a device to transmit data in contention in a superframe in which a beacon is not received if a number of consecutive beacon reception fails in the device does not exceed a predetermined value, in response to a request to set the pseudo contention access period; and
broadcasting the first frame.

15. The method of claim 14, wherein the first frame is a beacon frame.

16. The method of claim 15, wherein the generating of the first frame comprises adding to a frame body a pseudo contention access period information element field having the information on the pseudo contention access period recorded therein.

17. The method of claim 15, wherein the generating of the first frame comprises adding to a piconet synchronization parameters field a pseudo contention access period parameter having the information on the pseudo contention access period recorded therein.

18. The method of claim 16, wherein the information on the pseudo contention access period indicates a time when the pseudo contention access period ends.

19. The method of claim 17, wherein the information on the pseudo contention access period indicates a time when the pseudo contention access period ends.

20. The method of claim 14, further comprising:
generating a second frame comprising information on a changed pseudo contention access period in response to a request to change the pseudo contention access period; and
broadcasting the second frame.

21. The method of claim 20, wherein the second frame is a beacon frame.

22. The method of claim 21, wherein the generating of the second frame comprises adding to a frame body a pseudo contention access period change information element field having a payload having the information on the changed pseudo contention access period recorded therein.

23. The method of claim 21, wherein the generating of the second frame comprises adding, to a piconet parameter change information element, a pseudo contention access period change parameter having the information on the changed pseudo contention access period recorded therein.

24. The method of claim 22, wherein the recorded information indicates a time when the pseudo contention access period ends and a superframe with which the changed pseudo contention access period begins.

25. The method of claim 23, wherein the recorded information indicates a time when the pseudo contention access period ends and a superframe with which the changed pseudo contention access period begins.

26. A system for wireless personal area network communication, comprising:
a piconet coordinator generating a beacon frame comprising information on a pseudo contention access period, which allows a device to transmit data in contention in a superframe in which a beacon is not received if a number of consecutive beacon reception fails in the device does not exceed a predetermined value, in response to a request to set the pseudo contention access period, and broadcasting the beacon frame; and
at least one device receiving the beacon frame comprising the information on the pseudo contention access period from the piconet coordinator and transmitting data to another device comprised in a piconet in contention using the information on the pseudo contention access period during the pseudo contention access period comprised in a superframe in which the device does not receive a beacon.

27. The system of claim 26, wherein the piconet coordinator generates another beacon frame comprising information on a changed pseudo contention access period in response to a request to change the pseudo contention access period and broadcasts said another beacon frame.

28. The system of claim 27, wherein the information on the changed pseudo contention access period indicates a time when the pseudo contention access period ends and a superframe with which the changed pseudo contention access period begins.
